(19) United States
(12) Patent Application Publication
(10) Pub. No.: US 2017/0282225 A1
(43) Pub. Date: Oct. 5, 2017

(54) METHOD FOR CARRYING OUT A CLEANING PROCESS IN A TANK CONTAINER

(71) Applicant: IFM ELECTRONIC GMBH, ESSEN (DE)

(72) Inventors: Walter Reichart, Fronreute (DE); Ralf Kriesen, Amtzell (DE); Lorenz Halbinger, Kisslegg (DE)

(73) Assignee: IFM ELECTRONIC GMBH, ESSEN (DE)

(21) Appl. No.: 15/470,979

(22) Filed: Mar. 28, 2017

(30) Foreign Application Priority Data
Apr. 5, 2016 (DE) 10 2016 205 573.9

(51) Int. Cl. B08B 9/093; B08B 9/46

(52) U.S. Cl. CPC B08B 9/093; B08B 9/46

(57) ABSTRACT

The invention relates to a method for the time control of an automated cleaning process in a tank container, wherein during the cleaning process cleaning liquid is sprayed onto the inner wall of the tank container by means of a spray head. According to the invention the following method steps are provided: detecting the heat removal of a heating element disposed in the flow-off area of the cleaning liquid; continuous determination of the state value of the cleaning liquid with regard to the two variables degree of contamination and spray rate by means of the heat removal; comparing the state value of the cleaning liquid in a quasi-stationary state with a target state value; and terminating the cleaning process when the current state value differs by less than a default value from a target state value.

### CROSS-REFERENCE TO RELATED APPLICATION

This application claims priority to Applicant's German Application No. DE 10 2016 205 573.9, filed Apr. 5, 2016, the entire disclosure of which is incorporated herein by reference.

### FIELD OF THE INVENTION

The present disclosure is directed generally to a method for carrying out a cleaning process in a tank container.

### BACKGROUND

Process and storage tanks are part of the direct components of a modern process plant. Here, the cleaning of these tanks and containers is a central and significant task, in particular if they are plants in the food or pharmaceutical industry. Typically, cleaning is carried out, especially in the case of the latter areas of application, by heated acid or alkaline based cleaning liquids which are applied onto the inner wall of the tank container by means of a spray head.

Modern tank systems are now predominantly hermetically sealed against the external environment such that during operation there is no possibility of a regular inspection of whether the cleaning inside the tanks has been carried out completely and thoroughly. Usually, the cleaning process is to be carried out via a time control according to empirical specifications.

As the state of the art EP 1 882 914 A2 is mentioned in which the cleaning of procedural containers, boilers or tanks is described. The monitoring of this cleaning process is sensor controlled. A sensor for detecting the heat removal of a heating element is, for example, known from DE 10 2013 209 951 A1.

However, it cannot always be ensured that the cleaning liquid also reaches difficult to clean areas, e.g. when individual nozzles of the spray head by means of which the cleaning liquid is distributed in the tank are clogged. In addition, the power supply associated with the necessary cleaning chemicals is an essential cost factor.

Not least, the cleaning process also should not last longer than necessary because during the cleaning process the tank system is not available, i.e. the production process as such is affected.

It is the object of the invention to carry out the cleaning process automated with little effort and to configure it as effectively and efficiently as possible.

The object is achieved by a method according to the features of claim 1. Advantageous embodiments of the invention are disclosed in the dependent claims.

### SUMMARY

According to the invention, the uniform distribution of the cleaning liquid and its degree of contamination are monitored by means of a calorimetric flow measurement. For this purpose, a heating element is disposed in the flow-off area of the cleaning liquid, wherein the flow-off area is the area in which the cleaning liquid after spraying on the tank wall flows downwardly. If the entire tank interior is to be cleaned the flow-off area thus extends over the entire surface of the inner wall of the tank. In particular, the heating element is to be disposed at the locations in the tank which according to empirical experience are generally difficult to clean.

After the cleaning process has been started the heating element permanently measures its heat removal, for example by detecting the electrical power which is necessary to maintain the heating element at a predetermined constant temperature. Herein, the heat removal is directly affected by the nature and composition of the medium flowing off. If, for example, the spray head is defective because it is (partially) clogged, no or a too small quantity of cleaning liquid flows over the heating element such that there is less heat removal as in the case when a sufficient quantity of cleaning liquid is present. Moreover, a cleaning liquid that is faced with dirt generates a different heat removal as if the cleaning liquid encounters a clean situation.

During an initialization cleaning process with an uncontaminated cleaning liquid with respect to an uncontaminated inner wall of the tank the target value of the heat removal is registered and stored. This target value is then permanently compared with the respective actual value. If actual and target values match it can be assumed that the actual flowing off medium is faced in every respect with a thoroughly purified situation, i.e. no more residues are present.

Here, “matching” of course includes a certain tolerance range which is defined as a default value within which the actual value may differ from the target value.

Advantageously, a plurality of heating elements are positioned at different points of the inner wall of the tank container, in particular also where a cleaning process is generally more difficult to be carried out. The cleaning process is terminated only if all heating elements measure the predetermined heat removal.

### BRIEF DESCRIPTION OF THE DRAWINGS

In the following, the invention is described based on an exemplary embodiment with reference to the drawing.

FIG. 1 is a schematic view of a tank container as is typically used in particular in the food industry, in accordance with an embodiment.

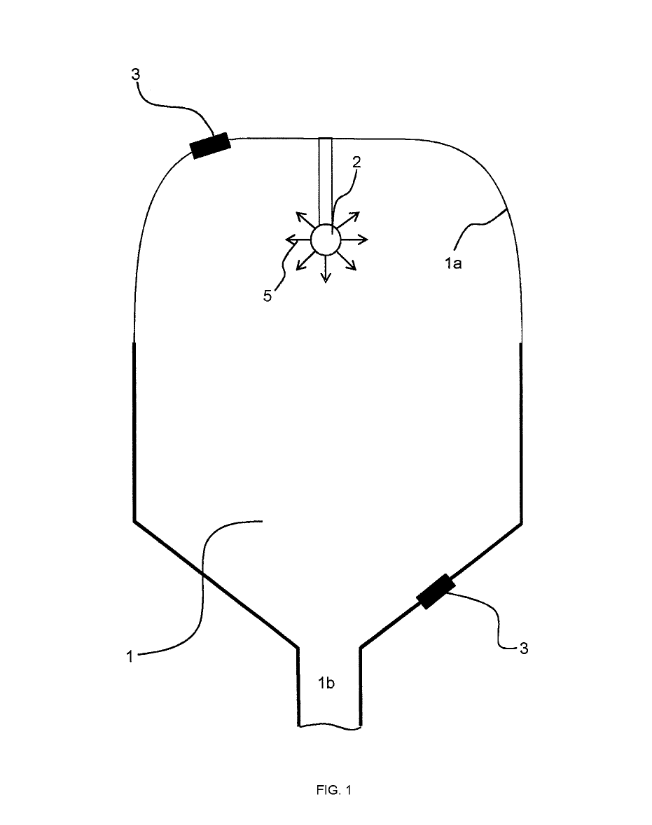

### DETAILED DESCRIPTION OF EMBODIMENTS

The tank container 1 is shown in the unfilled state; a previously contained medium has been drained via the drain 1b. However, as indicated by a somewhat thicker line a deposit on the inner wall 1a is indicated, since the tank container 1 usually cannot be emptied without residue. In the case of organic substances now there is a danger that microorganisms are produced. In order to avoid this, the tank containers 1 have to be cleaned regularly according to specific requirements.

A typical cleaning process includes that the inner wall 1a is first sprayed with an acid or alkaline based cleaning liquid of a temperature of about 60° C. and then, after all residues and dirt have been removed, is rinsed with about 5° C. cold clear water. The distribution of the cleaning liquid 5 is effected, for example, by means of a spray head 2, as indicated in the FIGURE. The distribution of the cleaning liquid 5 may be carried out in various ways, for example by means of a spray ball. However, it may happen that individual nozzles disposed on the spray ball are clogged such that the cleaning liquid 5 is not uniformly distributed. Accordingly, the inner wall 1a is possibly not uniformly sprayed or individual points are not sprayed at all under certain circumstances, such that the cleaning success is not obtained.

According to the invention, at least one heating element 3 is disposed in or at the inner wall 1a. Preferably a plurality of these heating elements 3 are positioned at different locations in or on the inner wall 1a in order to ensure the presence of the cleaning liquid anywhere on the inner wall 1a. In the FIGURE, the heating elements 3 are schematically illustrated as black boxes, wherein this merely is to indicate their basic positions and less their concrete configuration. The heating elements 3 can, in fact, protrude from or be embedded flush into the wall 1a or even be integrated into the wall such that the heating element 3 quasi “looks through” the wall 1a.

The heating element 3 is heated up to a certain over-temperature. The electrical power required therefor is detected. Depending on the medium, which flows down the inner wall 1a or its composition the heating element 3 is differently influenced in that a respective different heat removal is set. These differences are detected by a varying electrical power, which is necessary to set the constant over-temperature. The decisive criterion therefor is the temperature coefficient which changes depending on the composition of the medium.

Each heating element 3 is connected to a control and evaluation unit not shown in detail, which on the one hand provides for the regulation of the constant over-temperature and on the other hand compares the measured heat removal with a target value. This target value is determined in an initialization cleaning process with a clean, i.e. uncontaminated cleaning liquid and stored in the control and evaluation unit.

Another function of the control and evaluation unit is monitoring of the cleaning process. If the currently measured actual value deviates from the stored target value, i.e. if the actual state value differs from the target state value by less than a default value, the cleaning process is terminated.

What is claimed is:

1. A method for time control of an automated cleaning process in a tank container, wherein during the cleaning process cleaning liquid is sprayed onto the inner wall of the tank container by means of a spray head, comprising the following process steps:
a. detecting the heat removal of a heating element disposed in the flow-off area of the cleaning liquid;
b. continuously determining the state value of the cleaning liquid with regard to the two variables degree of contamination and spray rate by means of the heat removal;
c. comparing the state value of the cleaning liquid in a quasi-stationary state with a target state value, wherein the target state value has been derived in an initialization cleaning process in which the inner wall was uncontaminated and the discharge rate of the cleaning liquid (5) from the spray head (2) comprises a target rate;
d. terminating the cleaning process when the actual state value differs by less than a default value from the target state value.

2. The method according to claim 1, further comprising disposing a plurality of heating elements at the inner wall of the tank container and terminating the cleaning process only when the respective actual state value of each the individual heating element differs by less than a default value from the target state value.

3. The method according to claim 1, further comprising using a spray head which protrudes into the tank container to carry out the cleaning process
